(19) United States
(12) Patent Application Publication
(10) Pub. No.: US 2026/0319541 A1
(43) Pub. Date: Oct. 15, 2026

(54) INTEGRATED PHOTONIC OPTICAL SYSTEM FOR PERFORMING CONVOLUTION OPERATIONS

(71) Applicant: University of Florida Research Foundation, Incorporated, Gainesville, FL (US)

(72) Inventors: Volker J. Sorger, Gainesville, FL (US); Russell L. T. Schwartz, Gainesville, FL (US); Hangbo Yang, Gainesville, FL (US); Nicola Peserico, Gainesville, FL (US)

(21) Appl. No.: 19/573,815

(22) Filed: Mar. 20, 2026

Related U.S. Application Data
(60) Provisional application No. 63/786,633, filed on Apr. 10, 2025.

(51) Int. Cl. G06E 1/00

(52) U.S. Cl. CPC G06E 1/00

(57) ABSTRACT

An integrated photonic optical system comprising a pair of on-chip Fourier lenses, wherein the pair of on-chip Fourier lenses comprise (i) a first lens that is configured to generate Fourier domain data by providing a Fourier transformation of an input vector from a spatial domain to a frequency domain, and (ii) a second lens that is configured to generate inverse Fourier transformed data by providing an inverse Fourier transformation of the Fourier domain data from the frequency domain to the spatial domain; a pair of optoelectronic modulator banks that are configured to filter and apply input data corresponding to the input vector in a Fourier domain or the spatial domain for the pair of on-chip Fourier lenses; and a photodetector array that is configured to (i) receive the inverse Fourier transformed data from the second lens and (ii) apply a non-linear effect to the inverse Fourier transformed data.

### CROSS REFERENCE TO RELATED APPLICATION

This application claims the priority of U.S. Provisional Application No. 63/786,633, entitled “INTEGRATED PHOTONIC OPTICAL SYSTEM FOR PERFORMING CONVOLUTION OPERATIONS,” filed on Apr. 10, 2025, the disclosure of which is hereby incorporated by reference in its entirety.

### GOVERNMENT SUPPORT

This invention was made with government support under Grant No. N00014-23-1-2687, awarded by the U.S. Navy, Office of Naval Research. The government has certain rights in the invention.

### BACKGROUND

Traditional hardware for computing convolutions face limitations in energy and speed. For example, conventional graphics processing units (GPUs) may be used to compute convolutions, mainly in convolution neural networks (CNNs), but face a limitation in power consumption and may be limited to a clock rate of associated electronic components. Thus, as workloads grow, traditional computing hardware causes bottlenecks in the performance of existing computer architectures.

### BRIEF SUMMARY

Various embodiments described herein relate to an integrated photonic optical system for performing convolution operations.

According to some embodiments, an integrated photonic optical system comprises a pair of on-chip Fourier lenses, wherein the pair of on-chip Fourier lenses comprise (i) a first lens that is configured to generate Fourier domain data by providing a Fourier transformation of an input vector from a spatial domain to a frequency domain and (ii) a second lens that is configured to generate inverse Fourier transformed data by providing an inverse Fourier transformation of the Fourier domain data from the frequency domain to the spatial domain; a pair of optoelectronic modulator banks that are configured to filter and apply input data corresponding to the input vector in a Fourier domain or the spatial domain for the pair of on-chip Fourier lenses; and a photodetector array that is configured to (i) receive the inverse Fourier transformed data from the second lens and (ii) apply a non-linear effect to the inverse Fourier transformed data.

In some embodiments, the pair of on-chip Fourier lenses comprise one or more slotted lenses or one or more meta-surface lenses. In some embodiments, the pair of optoelectronic modulator banks comprises one or more of micro-ring modulators (MRMs), micro-disk modulators (MDMs), Mach-Zehnder modulators (MZMs), electro-absorption modulators (EAMs), or non-volatile material-based modulators. In some embodiments, the photodetector array (i) is configured to capture and convert one or more optical signals into one or more electrical signals and (ii) comprises one or more of silicon P-type, intrinsic, or N-type (PIN) photodetectors, silicon germanium (SiGe) avalanche photodetectors (APDs), element group III-V photodetectors, resonant cavity enhanced (RCE) photodetectors, or two-dimensional (2D) material-based photodetectors. In some embodiments, the input data is arrayed based on a domain implementation, wherein the domain implementation comprises one or more spatial or wavelength divisions. In some embodiments, the integrated photonic optical system further comprises a phase alignment subsystem that is configured to perform a phase front correction on the input vector. In some embodiments, the phase front correction comprises correcting a phase per line of a plurality of lines such that variation on the plurality of lines is canceled out. In some embodiments, the phase alignment subsystem comprises one or more thermo-optic phase shifters. In some embodiments, the integrated photonic optical system further comprises one or more input splitters that are configured to divide a coherent light source into a plurality of channels. In some embodiments, the pair of optoelectronic modulator banks comprises a first modulator bank configured to modulate the plurality of channels with the input data into the input vector; and a second modulator bank configured to convolve kernel data with the Fourier domain data from the first lens.

In some embodiments, the integrated photonic optical system further comprises a printed circuit board interface configured to couple the integrated photonic optical system to one or more electrical controllers. In some embodiments, the integrated photonic optical system further comprises a kernel dot-product engine that comprises one or more of MZMs, MRMs, MDMs, variable optical attenuators, optical amplifiers, or complementary metal-oxide semiconductor (CMOS) computations that are reapplied through modulation via optical-electrical-optical (O-E-O) conversion. In some embodiments, the integrated photonic optical system comprises a monolithic or heterogeneous integration with an advanced packaging of an electrical or photonic integrated circuit. In some embodiments, the integrated photonic optical system is configured to accelerate one or more convolution operations of a convolutional neural network (CNN).

According to some embodiments, a method for performing optical convolution operations comprises dividing, by one or more input splitters, a coherent light source into a plurality of channels; modulating, by a first modulator bank, the plurality of channels with input data into an input vector; generating, by a first lens, Fourier domain data by providing a Fourier transformation of the input vector from a spatial domain to a frequency domain; generating, by a second modulator bank, convolved data by convolving kernel data with the Fourier domain data; generating, by a second lens, inverse Fourier transformed data by providing an inverse Fourier transformation of the convolved data from the frequency domain to the spatial domain; and detecting, by a photodetector array, the inverse Fourier transformed data.

In some embodiments, the method further comprises applying, by the photodetector array, a non-linear effect to the inverse Fourier transformed data. In some embodiments, the method further comprises performing, by a phase alignment subsystem, a phase front correction on the input vector prior to providing the input vector to the first lens. In some embodiments, the phase front correction comprises correcting a phase per line of a plurality of lines such that variation on the plurality of lines is canceled out to satisfy a coherent phase front for the first lens. In some embodiments, modulating the plurality of channels with the input data comprises spatially encoding the input data using an array of optical modulators. In some embodiments, detecting the inverse Fourier transformed data comprises capturing and converting, using one or more photodiodes, one or more optical signals into one or more electrical signals.

### BRIEF DESCRIPTION OF THE DRAWINGS

Embodiments incorporating teachings of the present disclosure are shown and described with respect to the figures presented herein.

FIG. 1 depicts an example overview of an architecture in accordance with some embodiments of the present disclosure.

FIG. 2 depicts an example computing entity in accordance with some embodiments of the present disclosure.

FIG. 3 depicts an example client computing entity in accordance with some embodiments of the present disclosure.

FIG. 4 depicts a block diagram of an example integrated photonic optical system in accordance with some embodiments of the present disclosure.

FIG. 5 depicts a block diagram of an example phase aligning integrated photonic optical system in accordance with some embodiments of the present disclosure.

FIG. 6 is a flowchart of an example process for performing optical convolution operations in accordance with some embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Example Technical Improvements

The present disclosure provides an integrated photonic optical system that uses on-chip Fourier optics to provide more efficient convolution operations by leveraging on-chip Fourier transformations and optical convolution to simplify implementation while maintaining scalability. In some embodiments, an integrated photonic optical system comprises on-chip lenses that are configured to perform convolutions by leveraging Fourier optics, thereby reducing computational complexity, optimizing the performance of on-chip transformations, and/or saving power per operation. Accordingly, the integrated photonic optical system of the present disclosure may provide substantial scaling that is capable of handling substantial AI workloads with improved performance and minimal resource requirements.

### Example Technical Implementation of Various Embodiments

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable storage media (including volatile and non-volatile media).

A non-volatile computer-readable storage medium may include one or more magnetic and/or electro-mechanical storage devices, such as floppy disk(s), hard disk(s), magnetic tape, punch card(s), paper tape(s), optical mark sheet(s) (or any other physical medium with patterns of holes or other optically or mechanically detectable indicia), any other non-transitory magnetic medium, and/or the like. A non-volatile computer-readable storage medium may additionally or alternatively include one or more optical storage devices, such as compact disc read only memory (CD-ROM), compact disc-rewritable (CD-RW), any other non-transitory optical medium, and/or the like. A non-volatile computer-readable storage medium may additionally or alternatively include one or more read-only memory (ROM); programmable read-only memory (PROM); erasable programmable read-only memory (EPROM); electrically erasable programmable read-only memory (EEPROM), such as flash memory; and/or the like. In some examples, flash memory may comprise a set of field effect transistors and/or other devices or circuitry that implement serial and/or parallel NAND, NOR, and/or other hardware logic for storing data. In some examples, solid state storage (SSS), such as a solid state drive (SSD), flash drive, solid-state hybrid drives (SSHDs), and/or the like may include flash memory (SSHDs are a hybrid device that may include a hard disk and flash memory in some examples); and, in some examples, flash memory may be used as cache memory, implemented as a basic input output system (BIOS) chip or part of a BIOS chip, and/or the like. A non-volatile computer-readable storage medium may additionally or alternatively include 3D XPoint memory, non-volatile random access memory (NVRAM) (e.g., bridging random access memory (CBRAM), phase-change random access memory (PRAM), magnetoresistive random-access memory (MRAM), ferroelectric random-access memory (FeRAM)), racetrack memory, and/or the like. A non-volatile computer-readable storage medium may additionally or alternatively include one or more thermo-mechanical storage devices, such as Millipede memory; one or more molecular memory repositories; and/or the like.

A volatile computer-readable storage medium may include random access memory (RAM), dynamic random access memory (DRAM), static random access memory (SRAM), synchronous dynamic random access memory (SDRAM), cache memory (including various levels), register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Architecture

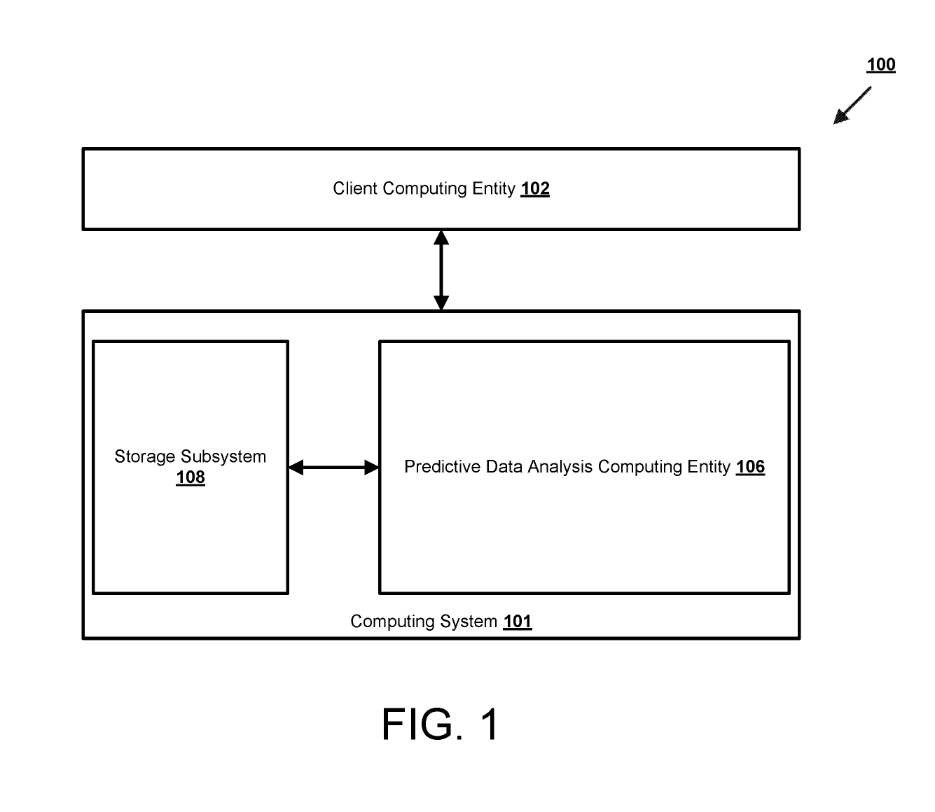

FIG. 1 depicts an example overview of an architecture 100 in accordance with some embodiments of the present disclosure. The architecture 100 includes a computing system 101 configured to receive a predictive task and/or data analysis request, such as a (machine learning model) prompt or input, and/or the like, from client computing entity 102, process the predictive data analysis request to generate a response (e.g., prediction, classification, or model output), and provide the response to the client computing entity 102.

In some embodiments, computing system 101 may communicate with at least one of the client computing entity 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive data analysis computing entity 106 and a storage subsystem 108. The predictive data analysis computing entity 106 may be configured to receive a predictive task and/or data analysis request, such as a (machine learning model) prompt or input, and/or the like, from client computing entity 102, process the predictive data analysis request to generate a response (e.g., prediction, classification, or model output), and provide the response to the client computing entity 102.

The storage subsystem 108 may be configured to store input data, training data, and/or the like that may be used by the predictive data analysis computing entity 106 to perform predictive data analysis and/or training operations of the present disclosure. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Example Data Analysis Computing Entity

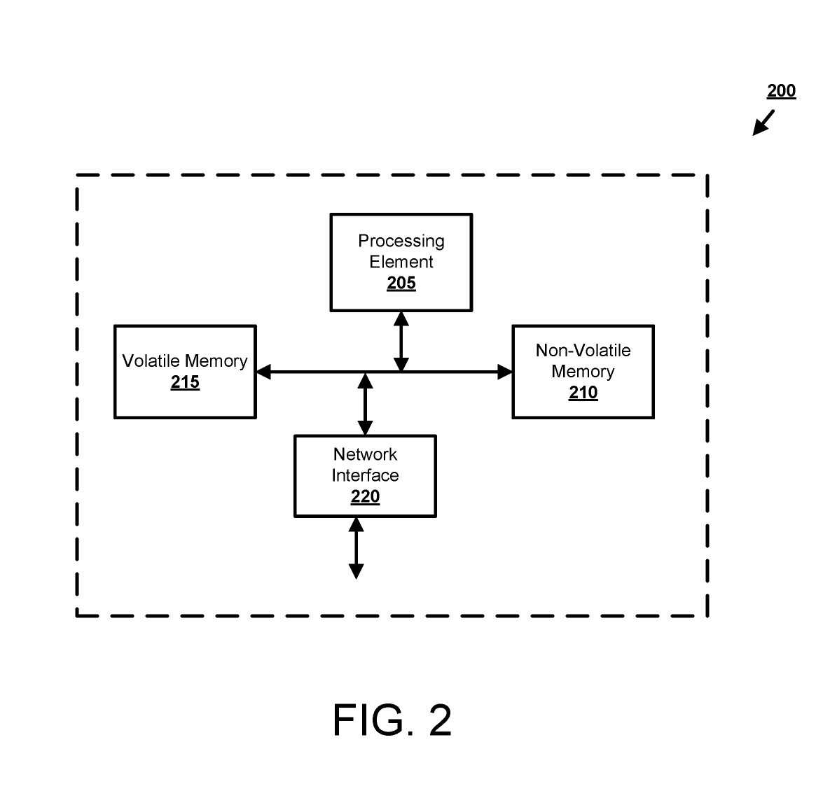

FIG. 2 depicts an example computing entity 200 in accordance with some embodiments of the present disclosure. The computing entity 200 is an example of the predictive data analysis computing entity 106. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes may be performed on data, content, information, and/or similar terms used herein interchangeably.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like.

As shown in FIG. 2, in one embodiment, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing elements 205 may be embodied in a number of different ways.

For example, the processing elements 205 may be embodied as one or more complex programmable logic devices (CPLDs), microprocessors, multi-core processors, coprocessing entities, application-specific instruction-set processors (ASIPs), microcontrollers, and/or controllers. Further, the processing elements 205 may be embodied as one or more other processing devices or circuitry. The term circuitry may refer to an entirely hardware embodiment or a combination of hardware and computer program products. In some embodiments, the circuitry may comprise photonic integrated circuit (PIC) components, such as modulator banks, on-chip lenses, and photodetectors, as disclosed herewith. Thus, the processing elements 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing elements 205 may be configured for a particular use or configured to execute instructions stored in volatile or non-volatile media or otherwise accessible to the processing elements 205. As such, whether configured by hardware or computer program products, or by a combination thereof, the processing elements 205 may be capable of performing steps or operations according to embodiments of the present disclosure when configured accordingly.

In one embodiment, the computing entity 200 may further include, or be in communication with, non-volatile media (also referred to as non-volatile storage, memory, memory storage, memory circuitry, and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity–relationship model, object model, document model, semantic model, graph model, and/or the like.

In one embodiment, the computing entity 200 may further include, or be in communication with, volatile media (also referred to as volatile storage, memory, memory storage, memory circuitry, and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing elements 205. Thus, the databases, database instances, database management systems, data, applications, programs, program modules, scripts, source code, object code, byte code, compiled code, interpreted code, machine code, executable instructions, and/or the like may be used to control certain aspects of the operation of the computing entity 200 with the assistance of the processing elements 205 and operating system.

As indicated, in one embodiment, the computing entity 200 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 200 may be configured to communicate via wireless external communication networks using any of a variety of protocols, such as new radio (NR), general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### Example Client Computing Entity

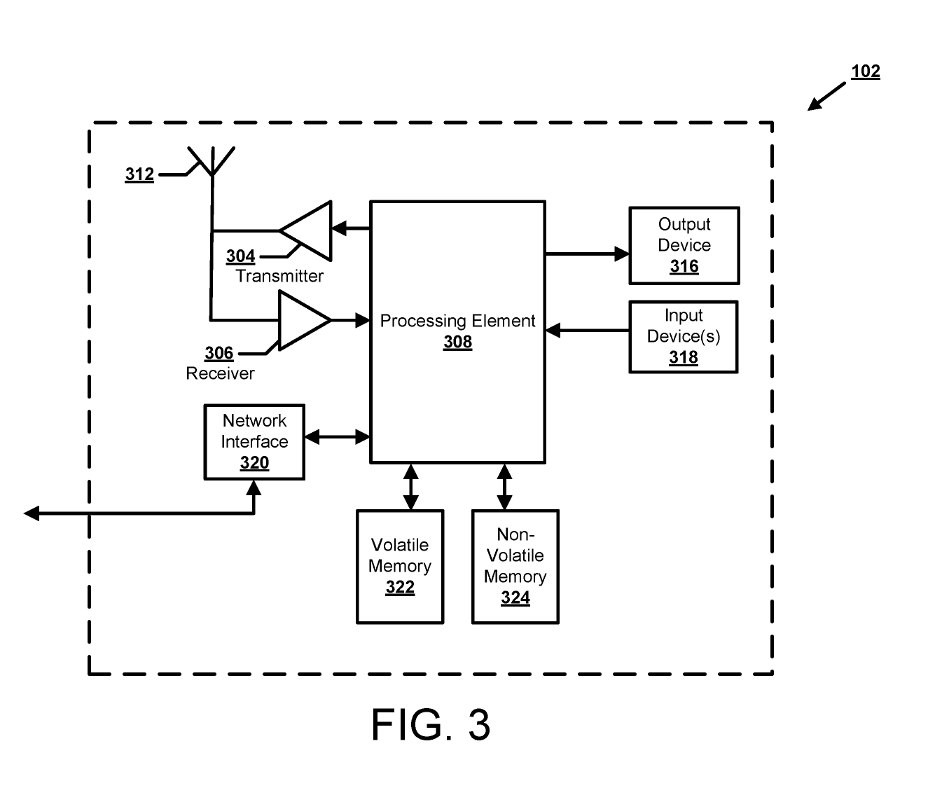

FIG. 3 depicts an example client computing entity 102 in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entity 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly. In some embodiments, the processing element 308 may be embodied as one or more other processing devices or circuitry similar to that of processing elements 205.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In a particular embodiment, the client computing entity 102 may operate in accordance with multiple wireless communication standards and protocols, such as NR, GPRS, UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the client computing entity’s 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input devices. In some embodiments including a keypad, the keypad may include (or cause display of) the conventional numeric (0-9) and related keys (#, *), and other keys used for operating the client computing entity 102 and may include a full set of alphabetic keys or a set of keys that may be activated to provide a full set of alphanumeric keys. In addition to providing input, the user input interface may be used, for example, to activate or deactivate certain functions, such as screen savers and/or sleep modes.

The client computing entity 102 may also include volatile storage or memory 322 and/or non-volatile storage or memory 324, which may be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. As will be recognized, these architectures and descriptions are provided for exemplary purposes only and are not limited to the various embodiments.

In various embodiments, the client computing entity 102 may be embodied as an artificial intelligence (AI) computing entity. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example Integrated Photonic Optical System Architecture

Various embodiments of the present disclosure describe integrated photonic optical systems for reducing the computational complexity of convolutions from O(N⁴) to O(N²).

Silicon photonics may leverage the properties of light, using optical components, such as integrated lenses, to leverage Fresnel approximation Fourier transformation while maintaining or exceeding high-speed operations of traditional computing systems. By combining such optical components on a silicon chip, faster data processing and reduced energy consumption over traditional computing hardware in performing and/or accelerating convolution operations for applications, such as convolution neural networks (CNNs) and artificial intelligence (AI) systems, may be achieved.

An integrated photonic optical system of the present disclosure may achieve faster, more energy-efficient performance than traditional computing hardware by utilizing principles, such as Fourier optics and convolution theorem. In some embodiments, an integrated photonic optical system comprises a pair of on-chip lenses that are configured to perform more efficient, scalable convolution operations, and minimize space and power requirements. By utilizing on-chip Fourier lenses to transform input data into the frequency domain, performing element-wise multiplication with kernel data, and then applying an inverse Fourier transformation, the integrated photonic optical system of the present disclosure may avoid computationally expensive electronic convolution operations. In some embodiments, the integrated photonic optical system further comprises optical modulators that provide precise data modulation and photodetectors that provide data detection and a non-linear activation function for CNNs. Accordingly, the integrated photonic optical system of the present disclosure may leverage the parallelism and speed of photonic computing to handle large-scale convolution tasks with reduced energy consumption.

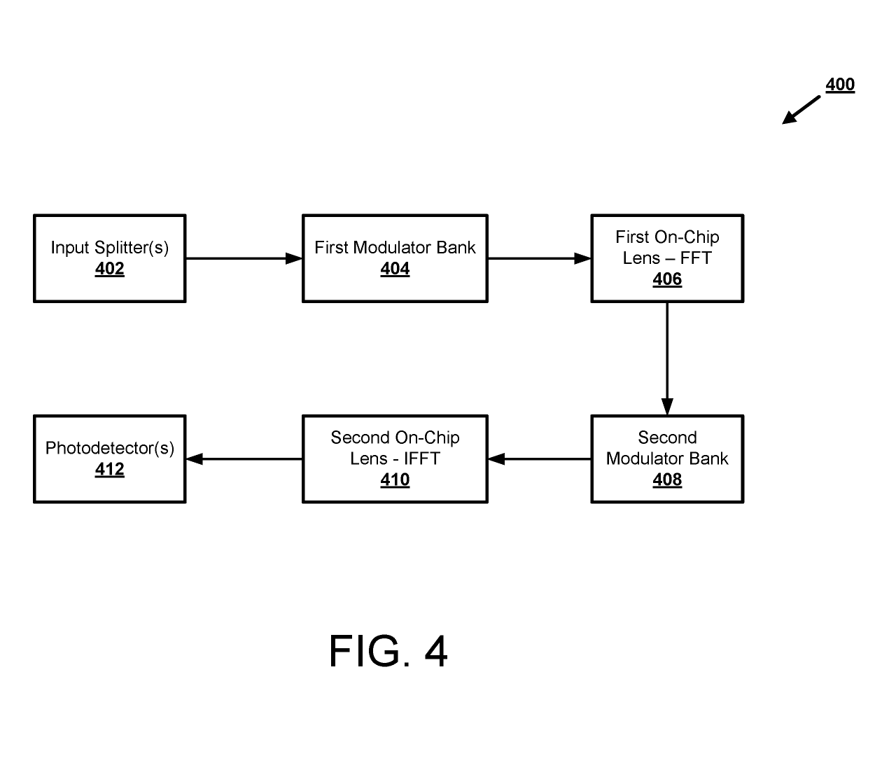

FIG. 4 depicts a block diagram of an example integrated photonic optical system 400 in accordance with some embodiments of the present disclosure. The integrated photonic optical system 400 comprises one or more input splitters 402 that are configured to divide a coherent light source into a plurality of channels (e.g., 16). A first modulator bank 404 (e.g., a high-speed micro-ring modulator (MRM)) is configured to receive and modulate the plurality of channels with input data into an input vector. The input vector may be provided to a first on-chip lens 406 for a first domain conversion (e.g., Fourier transformation) by the first on-chip lens 406. A convolution may be performed on Fourier domain data from the first on-chip lens 406 by remodulating the Fourier domain data with kernel data by a second modulator bank 408. Data convolved by the second modulator bank 408 may be inverse Fourier transformed by a second on-chip lens 410 and detected with one or more photodetectors 412.

In some embodiments, the first modulator bank 404 comprises a first array of optical modulators that are configured to spatially encode input data. The spatial encoding may comprise modulating the amplitude and/or phase of the optical signals in each channel of the plurality of channels to represent the input data values. For example, the first modulator bank 404 may receive the plurality of channels from the one or more input splitters 402 and apply modulation to each channel based on corresponding input data values, thereby generating the input vector. The first array of optical modulators may enable parallel encoding of multiple data elements simultaneously, which may improve throughput and processing speed. In some embodiments, the second modulator bank 408 comprises a second array of modulators that are configured to convolve kernel data with the encoded input data. The first modulator bank 404 and the second modulator bank 408 may comprise various types of modulators that optimize system performance in terms of speed, power-efficiency, reconfigurability, and/or footprint.

In some embodiments, the first on-chip lens 406 and the second on-chip lens 410 are configured to provide optical Fourier transformations, thereby reducing complex electronics, and allowing for faster, energy-efficient convolutions. In some embodiments, (a) the first on-chip lens 406 is configured to provide a first Fourier transformation that transforms the input vector from a spatial domain to a frequency domain and (b) the second on-chip lens 410 is configured to provide a second (inverse) Fourier transformation that transforms data from the frequency domain to the spatial domain. In some embodiments, the one or more photodetectors 412 comprise photodiodes that are configured to capture and convert optical signals into electrical signals with an automatic non-linear function, thereby facilitating seamless integration with electronic systems.

As an example, the integrated photonic optical system 400 may comprise a pair of on-chip Fourier lenses that are configured to provide a Fourier transformation or an inverse Fourier transformation; a pair of optoelectronic modulator banks that are configured to filter and apply input data in a Fourier domain or a spatial domain for a first on-chip Fourier lens of the pair of on-chip Fourier lenses; and a photodetector array that is configured to (i) receive inverse Fourier transformed data from a second on-chip Fourier lens of the pair of on-chip Fourier lenses and (ii) apply a non-linear effect to the inverse Fourier transformed data. The non-linear effect may arise from the inherent characteristics of the photodetectors, such as the square-law detection property of photodiodes, which may provide an automatic non-linear activation function suitable for neural network applications. In some embodiments, the photodiodes capture optical signals by absorbing photons and generating corresponding electrical currents proportional to the optical power. The conversion of optical signals into electrical signals may enable seamless integration with electronic processing systems for further computation or output. In some embodiments, the non-linear response of the photodetector array provides an activation function for convolutional neural network layers.

In some embodiments, the pair of on-chip Fourier lenses comprise slotted lenses or meta-surface lenses. In some embodiments, the pair of optoelectronic modulator banks comprise one or more of MRMs, micro-disk modulators (MDMs), Mach-Zehnder modulators (MZMs), electro-absorption modulators (EAMs), or non-volatile material-based modulators. In some embodiments, the photodetector array (i) is configured to capture and convert optical signals into electrical signals and (ii) comprises one or more silicon P-type, intrinsic, and N-type (PIN) photodetectors, one or more silicon germanium (SiGe) avalanche photodetectors (APDs), one or more element group III-V photodetectors, one or more resonant cavity enhanced (RCE) photodetectors, or one or more two-dimensional (2D) material-based photodetectors. In some embodiments, the input data is arrayed using a domain implementation, wherein the domain implementation comprises spatial or wavelength divisions.

### Data Conversion Inefficiencies

In some embodiments, a printed circuit board (PCB) interface is configured to couple the integrated photonic optical system 400 to one or more electrical controllers, enabling system integration and management. The PCB interface may couple the integrated photonic optical system 400 to the one or more electrical controllers by providing electrical connections for control signals, data input, and data output. The PCB may facilitate control signal routing, power supply distribution, and data input and output, ensuring optimal functionality. To reduce energy loss and latency that may impact overall system efficiency resulting from converting signals between optical and electrical domains as well as between the digital and analog domain via a PCB, monolithic and heterogeneous integration with advanced packaging of electrical and photonic integrated circuits may be implemented to minimize conversions. Monolithic integration may comprise fabricating both electrical and photonic components on a single substrate, while heterogeneous integration may comprise bonding or stacking separately fabricated electrical and photonic chips. Advanced packaging techniques may include through-silicon vias (TSVs), micro-bumps, or interposers to provide high-density interconnections between the electrical and photonic components, thereby reducing signal conversion overhead and improving overall system performance.

### Limited Channel Parallelism

In some embodiments, the integrated photonic optical system 400 comprises a plurality of channels that are processed in parallel to improve throughput and overall performance. For example, the integrated photonic optical system 400 may comprise an architecture that enables two-dimensional (2D) expansion of the integrated photonic optical system 400 and increases the number of parallel channels. In some embodiments, a 2D expansion architecture comprises a plurality of parallel processing paths that are arranged in a grid configuration, where each processing path comprises its own set of modulators, lenses, and/or photodetectors. As such, a 2D expansion architecture may enable the integrated photonic optical system 400 to process larger input matrices or a plurality of convolution operations concurrently. In some embodiments, a plurality of channels is processed in parallel by distributing input data across a plurality of waveguide channels, where each waveguide channel is configured to carry a portion of the input data through the optical processing pipeline simultaneously. By doing so, throughput may be improved by enabling multiple convolution operations to be performed at the same time, thereby reducing overall processing latency and increasing the computational capacity of the integrated photonic optical system 400.

In some embodiments, the integrated photonic optical system 400 is configured to accelerate one or more convolution operations of a CNN. The one or more convolution operations may comprise applying learned kernel filters to input feature maps to extract features at various layers of the CNN. By performing the convolution operations optically using the on-chip Fourier lenses and modulator banks, the integrated photonic optical system 400 may achieve higher throughput and lower power consumption compared to electronic implementations. In some embodiments, the integrated photonic optical system 400 is used to accelerate inference operations in trained CNN models, where kernel data stored in the second modulator bank 408 may represent learned filter weights. Optical convolution performed by the integrated photonic optical system 400 may be particularly beneficial for CNN architectures with large kernel sizes or high-resolution input data, where the computational complexity reduction from O(N⁴) to O(N²) may provide significant performance advantages.

### Phase Mismatches

Discrepancies in the optical phase front may affect the accuracy of a Fourier transform and thus integrated photonic optical system performance. In some embodiments, an integrated photonic optical system comprises phase-loop control that is configured to perform phase correction to maintain signal integrity and ensure accurate data processing.

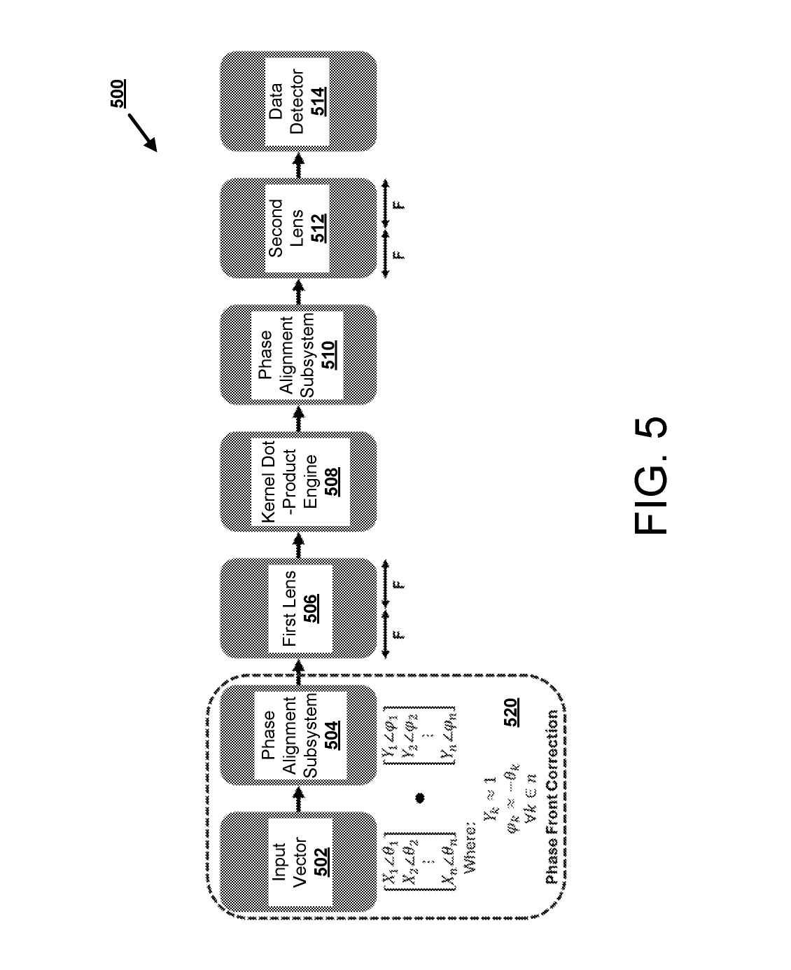

FIG. 5 depicts a block diagram of an example phase aligning integrated photonic optical system 500 in accordance with some embodiments of the present disclosure. The phase aligning integrated photonic optical system 500 comprises phase alignment subsystems 504 and 510 that are configured before entry to a first lens 506 and a second lens 512 (e.g., comprising on-chip Fourier lenses) for satisfying a coherent phase front for the first lens 506 and/or the second lens 512. The phase alignment subsystem 504 is configured to provide a phase front correction 520 that is applied on an input vector 502 (e.g., that corresponds to input data) provided to the phase alignment subsystem 504. Phase front correction 520 comprises correcting a phase per line of a plurality of lines such that variation on each line may be canceled out.

The phase alignment subsystems 504 and/or 510 may employ a universal approach of handling the input vector 502 and a kernel dot-product engine 508. For example, a Kramers-Kronig relationship between imaginary and real parts of a refractive index provides that any modulation scheme where a refractive index is being changed, induces both an amplitude and phase change. As such, the phase alignment subsystems 504 and/or 510 may account for such and other potential unwanted phase changes in an amplitude modulation scheme, by applying a phase change which introduces a minimal amplitude change prior to lens input. The phase alignment subsystems 504 and/or 510 may also account for phase deviation that does not depend on a specific modulator comprising a thermo-optic effect and a plasma dispersion effect, but rather, any modulation scheme may be applied by correcting for phase in a separate component. For example, phase correction performed by the phase alignment subsystem 504 may ensure that the first lens 506 performs an accurate Fourier transformation, as the Fourier transform operation may rely on coherent interference of the optical signals. In some embodiments, the phase alignment subsystems 504 and/or 510 may continuously monitor and adjust the phase corrections to maintain signal integrity throughout the convolution operation.

The phase alignment subsystems 504 and 510 may comprise one or more of, but is not limited to, thermo-optic phase shifters. The input vector 502 may comprise one or more of , but is not limited to, MZMs, MRMs and/or MDMs, variable optical attenuators, or optical amplifiers. The kernel dot-product engine 508 may comprise one or more of, but is not limited to, MZMs, MRMs and/or MDMs, variable optical attenuators, optical amplifiers, or complimentary metal-oxide semiconductors (CMOS) computations reapplied through modulation (e.g., optical-electrical-optical (O-E-O) conversion). The data detector 514 may comprise one or more photodetectors, such as photodiodes, that are configured to receive inverse Fourier transformed data from the second lens 512.

### Example System Operations

Various embodiments of the present disclosure describe steps, operations, processes, methods, functions, and/or the like for performing optical convolution operations.

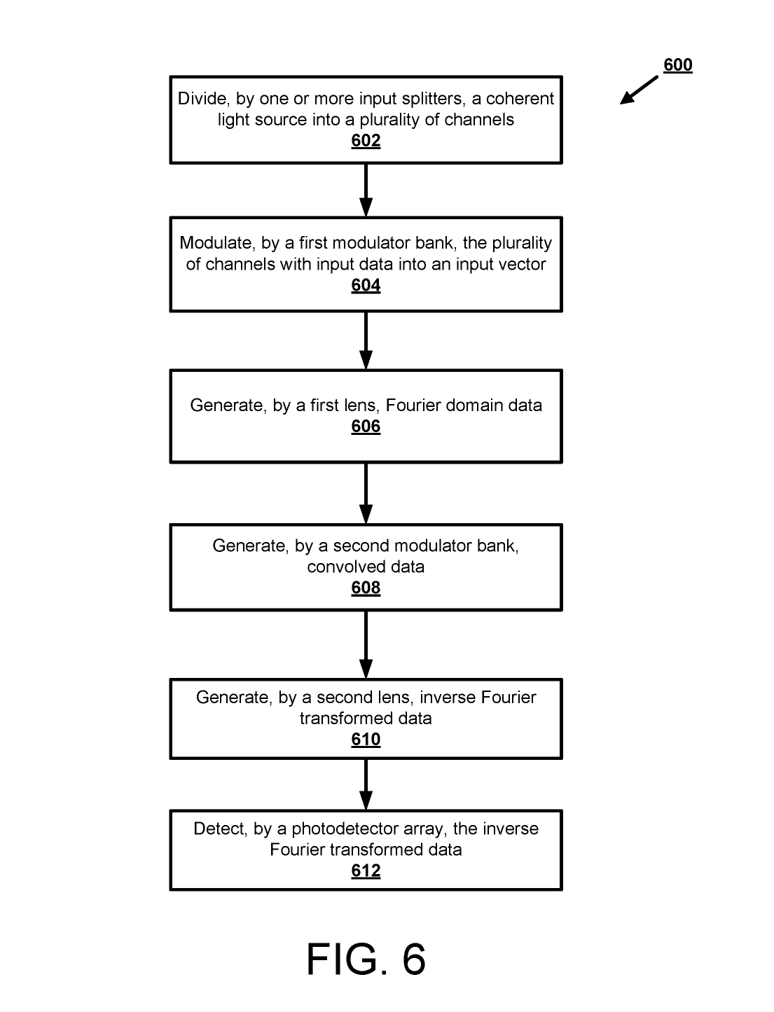

FIG. 6 is a flowchart of an example process 600 for performing optical convolution operations according to some embodiments of the present disclosure.

In some embodiments, the process 600 comprises, at operation 602, dividing, by one or more input splitters, a coherent light source into a plurality of channels.

In some embodiments, the process 600 comprises, at operation 604, modulating, by a first modulator bank, the plurality of channels with input data into an input vector.

In some embodiments, the process 600 comprises, at operation 606, generating, by a first lens, Fourier domain data by providing a Fourier transformation of the input vector from a spatial domain to a frequency domain;

In some embodiments, the process 600 comprises, at operation 608, generating, by a second modulator bank, convolved data by convolving kernel data with the Fourier domain data.

In some embodiments, the process 600 comprises, at operation 610, generating, by a second lens, inverse Fourier transformed data by providing an inverse Fourier transformation of the convolved data from the frequency domain to the spatial domain.

In some embodiments, the process 600 comprises, at operation 612, detecting, by a photodetector array, the inverse Fourier transformed data.

In some embodiments, the process 600 further comprises applying, by the photodetector array, a non-linear effect to the inverse Fourier transformed data. In some embodiments, the process 600 further comprises performing, by a phase alignment subsystem, a phase front correction on the input vector prior to providing the input vector to the first lens. In some embodiments, the phase front correction comprises correcting a phase per line of a plurality of lines such that variation on the plurality of lines is canceled out to satisfy a coherent phase front for the first lens. In some embodiments, modulating the plurality of channels with the input data comprises spatially encoding the input data using an array of optical modulators. In some embodiments, detecting the inverse Fourier transformed data comprises capturing and converting, using one or more photodiodes, one or more optical signals into one or more electrical signals.

### Conclusion

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. An integrated photonic optical system comprising:
a pair of on-chip Fourier lenses, wherein the pair of on-chip Fourier lenses comprise:
(i) a first lens that is configured to generate Fourier domain data by providing a Fourier transformation of an input vector from a spatial domain to a frequency domain, and
(ii) a second lens that is configured to generate inverse Fourier transformed data by providing an inverse Fourier transformation of the Fourier domain data from the frequency domain to the spatial domain;
a pair of optoelectronic modulator banks that are configured to filter and apply input data corresponding to the input vector in a Fourier domain or the spatial domain for the pair of on-chip Fourier lenses; and
a photodetector array that is configured to (i) receive the inverse Fourier transformed data from the second lens and (ii) apply a non-linear effect to the inverse Fourier transformed data.

2. The integrated photonic optical system of claim 1, wherein the pair of on-chip Fourier lenses comprise one or more slotted lenses or one or more meta-surface lenses.

3. The integrated photonic optical system of claim 1, wherein the pair of optoelectronic modulator banks comprises one or more of micro-ring modulators (MRMs), micro-disk modulators (MDMs), Mach-Zehnder modulators (MZMs), electro-absorption modulators (EAMs), or non-volatile material-based modulators.

4. The integrated photonic optical system of claim 1, wherein the photodetector array (i) is configured to capture and convert one or more optical signals into one or more electrical signals and (ii) comprises one or more of silicon P-type, intrinsic, or N-type (PIN) photodetectors, silicon germanium (SiGe) avalanche photodetectors (APDs), element group III-V photodetectors, resonant cavity enhanced (RCE) photodetectors, or two-dimensional (2D) material-based photodetectors.

5. The integrated photonic optical system of claim 1, wherein the input data is arrayed based on a domain implementation, wherein the domain implementation comprises one or more spatial or wavelength divisions.

6. The integrated photonic optical system of claim 1 further comprising a phase alignment subsystem that is configured to perform a phase front correction on the input vector.

7. The integrated photonic optical system of claim 6, wherein the phase front correction comprises correcting a phase per line of a plurality of lines such that variation on the plurality of lines is canceled out.

8. The integrated photonic optical system of claim 6, wherein the phase alignment subsystem comprises one or more thermo-optic phase shifters.

9. The integrated photonic optical system of claim 1 further comprising one or more input splitters that are configured to divide a coherent light source into a plurality of channels.

10. The integrated photonic optical system of claim 9, wherein the pair of optoelectronic modulator banks comprises:
a first modulator bank configured to modulate the plurality of channels with the input data into the input vector; and
a second modulator bank configured to convolve kernel data with the Fourier domain data from the first lens.

11. The integrated photonic optical system of claim 1 further comprising a printed circuit board interface configured to couple the integrated photonic optical system to one or more electrical controllers.

12. The integrated photonic optical system of claim 1, further comprising a kernel dot-product engine comprising one or more of MZMs, MRMs, MDMs, variable optical attenuators, optical amplifiers, or complementary metal-oxide semiconductor (CMOS) computations that are reapplied through modulation via optical-electrical-optical (O-E-O) conversion.

13. The integrated photonic optical system of claim 1, wherein the integrated photonic optical system comprises a monolithic or heterogeneous integration with an advanced packaging of an electrical or photonic integrated circuit.

14. The integrated photonic optical system of claim 1, wherein the integrated photonic optical system is configured to accelerate one or more convolution operations of a convolutional neural network (CNN).

15. A method for performing optical convolution operations, the method comprising:
dividing, by one or more input splitters, a coherent light source into a plurality of channels;
modulating, by a first modulator bank, the plurality of channels with input data into an input vector;
generating, by a first lens, Fourier domain data by providing a Fourier transformation of the input vector from a spatial domain to a frequency domain;
generating, by a second modulator bank, convolved data by convolving kernel data with the Fourier domain data;
generating, by a second lens, inverse Fourier transformed data by providing an inverse Fourier transformation of the convolved data from the frequency domain to the spatial domain; and
detecting, by a photodetector array, the inverse Fourier transformed data.

16. The method of claim 15 further comprising applying, by the photodetector array, a non-linear effect to the inverse Fourier transformed data.

17. The method of claim 15 further comprising performing, by a phase alignment subsystem, a phase front correction on the input vector prior to providing the input vector to the first lens.

18. The method of claim 17, wherein the phase front correction comprises correcting a phase per line of a plurality of lines such that variation on the plurality of lines is canceled out to satisfy a coherent phase front for the first lens.

19. The method of claim 15, wherein modulating the plurality of channels with the input data comprises spatially encoding the input data using an array of optical modulators.

20. The method of claim 15, wherein detecting the inverse Fourier transformed data comprises capturing and converting, using one or more photodiodes, one or more optical signals into one or more electrical signals.
